(19) United States
(12) Patent Application Publication
(10) Pub. No.: US 2008/0100408 A1
(43) Pub. Date: May 1, 2008

(54) Inductor structure

(76) Inventor: Chih-Hua Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/679,138

(22) Filed: Feb. 26, 2007

Related U.S. Application Data
(62) Division of application No. 11/552,959, filed on Oct. 25, 2006.

(51) Int. Cl. H01F 5/00

(52) U.S. Cl. 336/200

(57) ABSTRACT

An inductor structure is disclosed in the present invention. The inductor structure is formed in a semiconductor substrate, in which a spiral first conductive layer and the topmost interconnect of a multilevel interconnection structure are simultaneously formed in a first dielectric layer, the first conductive layer has the same material as the topmost interconnect has, a second conductive layer and the via plug of the multilevel interconnection structure are simultaneously formed, the second conductive layer is filled in a trench opening in a second dielectric layer, beneath the first conductive layer, and attached to the bottom of the first conductive layer to become an integrated whole. Thus, the cross-sectional area of the conductive layer of the coil is increased and the resistance can be reduced to obtain higher Q factor.

### CROSS REFERENCE TO RELATED APPLICATIONS

This application is a division of applicant's earlier application Ser. No. 11/552,959, filed on Oct. 25, 2006, which is included herein by reference.

### BACKGROUND OF THE INVENTION

1. Field of the Invention

The present invention relates to an inductor structure, and particularly to an inductor structure formed in a semiconductor integrated circuit.

2. Description of the Prior Art

In the semiconductor industry, inductors built on silicon substrates are widely used in CMOS based RF circuits such as low-noise amplifiers, voltage-controlled oscillators, and power amplifiers. Conventional inductors that are created on the surface of a substrate are in a spiral shape, formed by semiconductor processes, such as sputtering and etching processes.

FIG. 1 shows a schematic plan view of a conventional inductor in a semiconductor integrated circuit. The inductor is fabricated using an interconnection structure manufacturing process of semiconductor industry. FIG. 2 shows a perspective view of part A in FIG. 1. The conventional inductor 10 is in a planar spiral shape and comprises a metal layer 12, a set of via plugs 14, and a metal layer 16 (not shown in FIG. 1). The metal layer 12 is formed simultaneously at the time of forming the topmost metal interconnect of the topmost interconnection layer and located in the dielectric layer 18 (not shown in FIG. 2) of the topmost interconnection layer. The metal layer 16 is formed simultaneously at the time of forming the metal interconnect of the previous interconnection layer. The via plug 14 is disposed between the metal layers 12 and 16 and electrically connected with both. The via plug 14 is consisted of the metal filled in the via. There may be a plurality of via plugs parallel arranged in, for example, two rows under the metal layer 12. The via plugs 14 are formed simultaneously at the time of forming the via plug of the interconnection structure. In the conventional techniques, a plurality of via plugs 14 are parallel arranged under the metal layer. In such structure, the surface area of the inductor coil can be increased due to these via plugs, and thus the Q factor is increased.

The metal layer of the inductor and the topmost interconnect layer have a same thickness because the inductor is formed using the place of the topmost interconnect layer, both being fabricated simultaneously. In a current 0.18 μm semiconductor manufacturing process, the thickness of the topmost interconnection layer is 20,000 Å, as well as the thickness of the metal layer of the inductor in this layer, such that the width and the space needed for the inductor coil line become large. For example, the width is about 1.2 μm, and the space is about 1.0 μm, such that the inductor obtained is relatively large and occupies too much area.

One important measure of an inductor is the quality factor or Q of the inductor. The Q of an inductor is given by equation (I) as:

$$Q = \frac{ω L}{R} \qquad ( 1 )$$

wherein, w is related to the frequency of the signal applied to the inductor, L represents the inductance of the inductor, and R represents the resistance of the inductor. The smaller the resistance R, the higher the Q factor of the inductor. High Q is desirable. One common approach is to reduce the resistance of an inductor for increasing Q. When a conductive line having a larger diameter is used to be the coil, R can be reduced. Therefore, in the fabrication of the inductor using the interconnection structure of the integrated circuit, the thicker the metal layer, and the smaller the resistance.

However, when the coil of an inductor has a thick metal layer, it tends to collapse if via plugs underlying the thick metal layer have a too small cross area. Therefore, in the conventional inductor structure, there is a conflict existing between hoping to increase the thickness of the metal layer of the inductor coil (that is also the thickness of the topmost metal interconnect) for reducing resistance and hoping to reduce the thickness of the topmost metal interconnect (that is the thickness of the metal layer of the inductor coil) for reducing the width and the space to avoid the collapse of the coil.

Furthermore, when rows of via plugs are arranged beneath the metal layer, in case that one of the via plugs is damaged and becomes not electric conductive, the electric properties of the inductor will be affected.

Therefore, there is still a need for a better inductor structure to solve the aforesaid problem.

### SUMMARY OF THE INVENTION

An object of the present invention is to provide an inductor structure utilizing the topmost interconnect layer and the underlying inter-metal dielectric layer or more underlying layers together as a space to form an inductor coil, such that the thickness of the interconnect layer can be reduced and, in turn, the width and the space of the coil can be reduced, as well as the cross area of the inductor conductive layer is increased and, in turn, the resistance can be reduced to obtain a relatively high Q factor.

The inductor structure according to the present invention is located in a semiconductor substrate, and the semiconductor substrate comprises a topmost interconnect in a first dielectric layer, a second dielectric layer under the first dielectric layer, and at least one via in the second dielectric layer and filled with a via plug connecting the topmost interconnect. The inductor structure comprises a first conductive layer and a second conductive layer. The first conductive layer is in a spiral shape, disposed in the first dielectric layer, and comprises a same material as the topmost interconnect. The second conductive layer is filled in a trench opening in the second dielectric layer beneath the first conductive layer and connects the bottom of the first conductive layer with its top. The second conductive layer has a same shape as the spiral shape and comprises a same material as the via plug.

In another embodiment of the present invention, the inductor structure according to the present invention is located in a semiconductor substrate. The semiconductor substrate comprises a topmost interconnect in a first dielectric layer, a second dielectric layer under the first dielectric layer, and at least one via in the second dielectric layer and filled with a via plug connecting the topmost interconnect. The inductor structure comprises a first conductive layer and a second conductive layer. The first conductive layer is in a spiral shape, filled in a trench opening in the first dielectric layer, and comprises a same material as the topmost interconnect. The second conductive layer is in the second dielectric layer beneath the first conductive layer and connects the bottom of the first conductive layer with its top. The second conductive layer has a same shape as the spiral shape and comprises a same material as the via plug.

The integrated circuit structure according to the present invention comprises a semiconductor substrate, a multilevel interconnection structure, and an inductor structure. The multilevel interconnection structure is formed on the semiconductor substrate and comprises a topmost interconnect in a first dielectric layer, a second dielectric layer under the first dielectric layer, and at least one via in the second dielectric layer and filled with a via plug connecting the topmost interconnect. The inductor structure comprises a first conductive layer and a second conductive layer. The first conductive layer is in a spiral shape disposed in the first dielectric layer and comprises a same material as the topmost interconnect. The second conductive layer is filled in a trench opening in the second dielectric layer beneath the first conductive layer and connects the bottom of the first conductive layer with its top. The second conductive layer is in a same shape as the spiral shape and comprises a same material as the via plug.

As compared with the conventional techniques, the inductor structure according to the present invention utilizes the topmost layer of an interconnection structure to form a conductive layer therein, and the underlying inter-metal dielectric layer to form a wall-shape-like trench plug therein, together forming an inductor coil. Thus, the cross-sectional area of the conductive layer of the coil is increased and the resistance can be reduced to obtain higher Q factor. Alternatively, the thickness of the conductive layer can be properly reduced to avoid the problem occurring to the large width and space of the conventional coil while maintaining a certain Q factor, and thus the device size can be minimized. Meanwhile, since the thickness of the conductive layer is reduced and the trench via is employed, a risk of coil collapse is very small.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic plan view of a conventional inductor in a semiconductor integrated circuit.

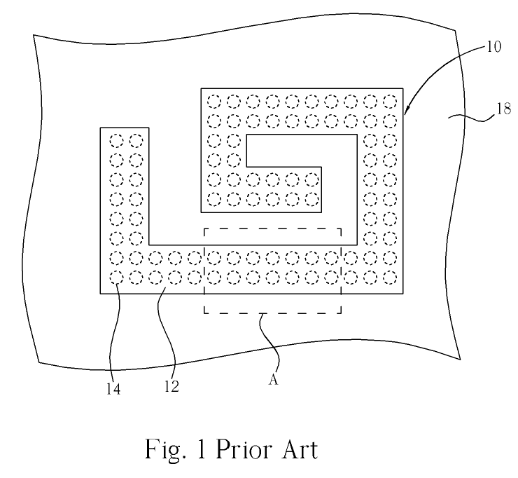

FIG. 2 shows a perspective view of part A in FIG. 1.

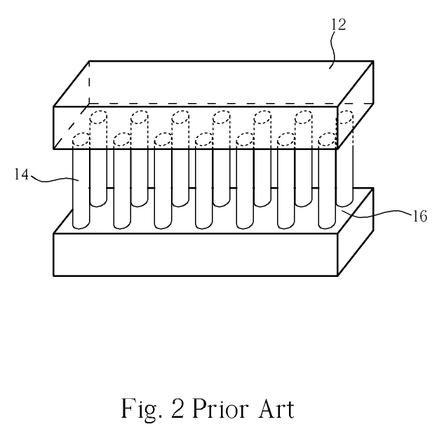

FIG. 3 shows a schematic plan view of the first embodiment according to the present invention.

FIG. 4 shows a cross-sectional view along line B-B′ in FIG. 3.

FIG. 5 shows a partial perspective view of the conductor structure shown in FIG. 3.

FIG. 6 shows a cross-sectional view of the second embodiment according to the present invention.

FIG. 7 shows a cross-sectional view of the third embodiment according to the present invention.

FIG. 8 shows a cross-sectional view of the fourth embodiment according to the present invention.

FIG. 9 shows a cross-sectional view of the fifth embodiment according to the present invention.

FIG. 10 shows a partial perspective view of the conductor structure shown in FIG. 9.

### DETAILED DESCRIPTION

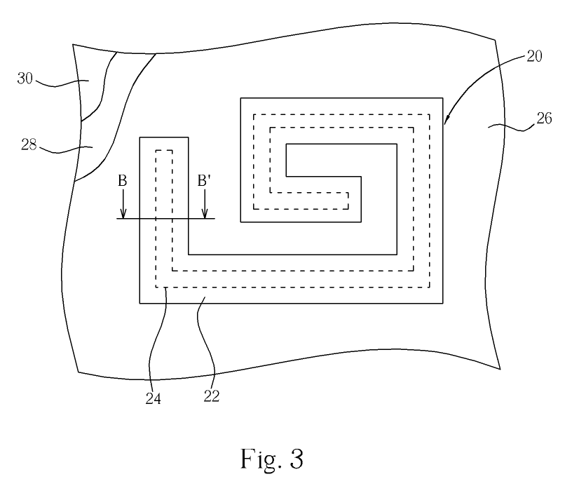

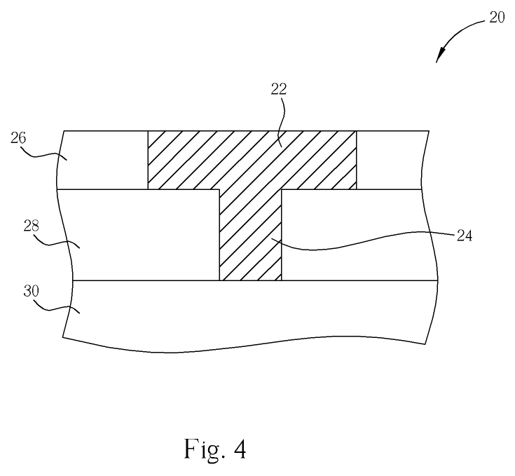

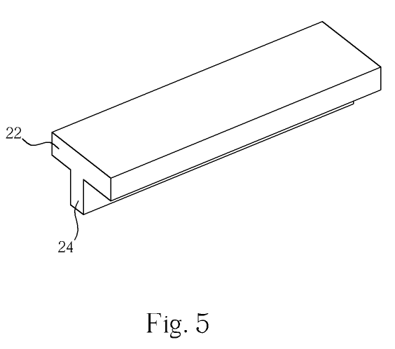

Please refer to FIGS. 3-5. FIG. 3 shows a schematically plan view of the first embodiment according to the present invention. FIG. 4 shows a schematically cross-sectional view along line B-B′ in FIG. 3. FIG. 5 shows a schematically partial perspective view of the conductor structure shown in FIG. 3. The inductor structure 20 is located in a semiconductor substrate 30. The semiconductor substrate 30 comprises a topmost interconnect (not shown) in a first dielectric layer 26, a second dielectric layer 28 under the first dielectric layer, and at least one via (not shown) in the second dielectric layer and filled with a via plug (not shown) connecting the topmost interconnect. The inductor structure 20 comprises a first conductive layer 22 and a second conductive layer 24. The first conductive layer 22 is in a spiral shape, disposed in the first dielectric layer 26, and comprises a same material as the topmost interconnect. The second conductive layer 24 is filled in a trench opening in the second dielectric layer 28 beneath the first conductive layer 22 and connects the bottom of the first conductive layer 22 with its top. The second conductive layer 24 has a same shape as the spiral shape which the first conductive layer 22 has and comprises a same material as the via plug.

Since the conductive layer of the inductor structure according to the present invention is formed simultaneously at the time of forming the contact plug, interconnect, or via plug of the interconnection structure, they comprise the same material, i.e. an electric conductive material, such as metal or other conductive material. Metal may be for example copper, copper alloy, aluminum, aluminum alloy, gold, gold alloy, silver, silver alloy, tungsten, etc., but not limited thereto. Tungsten and aluminum alloy may be used to form contact plugs or via plugs. When copper is used as the electric conductive material for metal interconnects, such as copper via plugs and copper conductive lines, since it is not easily etched, a copper single damascene or copper dual damascene process is usually performed.

When the interconnection structure is manufactured using a dual damascene process, such as trench-first, via-first, or partial-via-first dual damascene process, the first conductive layer 22 and the second conductive layer 24 are formed simultaneously by the dual damascene process used. In such situation, the first conductive layer 22 and the second conductive layer 24 are formed as a whole in structure and become a same layer. Thus, the first conductive layer 22 and the second conductive layer 24 may comprise copper since copper is commonly used in the dual damascene interconnection structure. There is preferably a barrier layer (not shown) disposed between the first conductive layer 22 and the first dielectric layer 26, and between the second conductive layer 24 and the second dielectric layer 28, when using copper as the conductive material. There may be an etch stop layer (not shown) between the first dielectric layer 26 and the second dielectric layer 28, or the first dielectric layer 26 and the second dielectric layer 28 may be formed continuously to be a single dielectric layer, depending on the damascene process used. The first conductive layer 22 and the second conductive layer 24 may comprise aluminum when the interconnection structure is fabricated through deposition of an aluminum metal or alloy followed by melting to be well filled in the trench or via. The first conductive layer 22 may comprise copper and the second conductive layer 24 may comprise tungsten when the interconnection structure is fabricated using a single damascene.

The thickness of the conductive layers of the inductor structure according to the present invention is approximately the same as the thickness of the layers of the interconnection structure. For example, the first conductive layer 22 has an approximately same thickness as the topmost interconnect, and the second conductive layer 24 has an approximately same thickness as the via plug beneath the topmost interconnect.

The first dielectric layer 26 and the second dielectric layer 28 comprise dielectric material commonly used in a conventional interconnection structure. The dielectric material may be for example silicon oxide, phosphosilicate glass (PSG), borophosphosilicate glass (BPSG), or a low-k dielectric, such as, fluorinated silica glass (FSG) or organosilicate glass (OSG).

The inductor structure according to the present invention is spiral, for example a circular spiral, a triangular spiral, or a polygonal spiral, such as a square, rectangular, etc. spiral.

It is noted that, in the conventional inductor structures, the conductive layer has a same thickness as the topmost interconnect, about 20,000 Å. Nevertheless, in the present invention, the thickness of the topmost interconnect (i.e. the thickness of the first conductive layer) can be reduced since the second conductive layer has an wall-shape-like structure and is combined with the first conductive layer to form a whole piece of a conductive coil with a large total thickness. The inductor structure keeps steady while the cross area of the coil is larger than that in the conventional techniques, such that the resistance is reduced and Q is increased.

In the inductor structure according to the present invention, the second conductive layer may be a plurality of layers, respectively filled in a plurality of trench openings parallel arranged in the second dielectric layer. It is considered that in case the second conductive layer is a single layer with a large width, when it is being fabricated, the filling of conductive layer material into the trench opening would not be easy and tend to result a gap therein. Thus, a plurality of trench openings, instead of only one, may be formed in the dielectric layer, such that the trench opening may have a smaller width and it is advantageous for the conductive layer material to fill in.

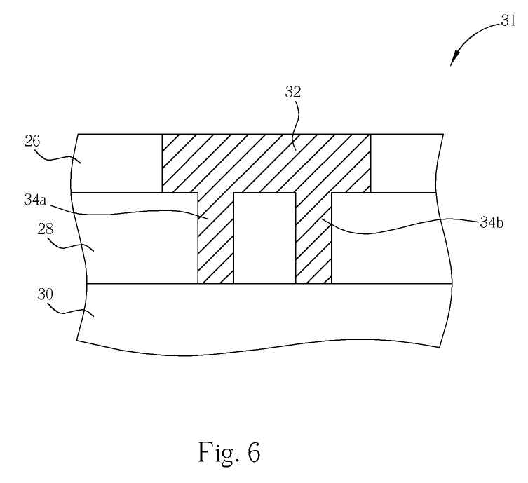

Please refer to FIG. 6 showing a cross-sectional view of the second embodiment according to the present invention. The inductor structure 31 is located in a semiconductor substrate 30. The semiconductor substrate 30 comprises a topmost interconnect (not shown) in a first dielectric layer 26, a second dielectric layer 28 under the first dielectric layer, and at least one via (not shown) in the second dielectric layer and filled with a via plug (not shown) connecting the topmost interconnect. The inductor structure 31 comprises a first conductive layer 32 and two second conductive layers 34a and 34b. The first conductive layer 32 is in a spiral shape, disposed in the first dielectric layer 26, and comprises a same material as the topmost interconnect. The second conductive layers 34a and 34b are respectively filled in two trench openings in the second dielectric layer 28 beneath the first conductive layer 32 and connect the bottom of the first conductive layer 22 with their tops. The second conductive layers 34a and 34b have a same shape as the spiral shape which the first conductive layer 32 has and comprise a same material as the via plug. The first conductive layer 32 and the second conductive layers 34a and 34b also may be formed as a whole and comprise the same material as described above.

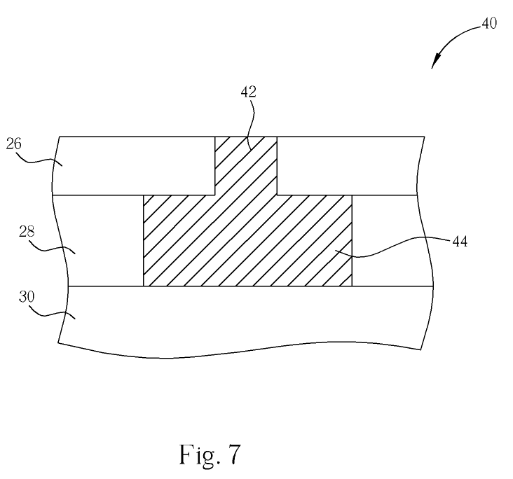

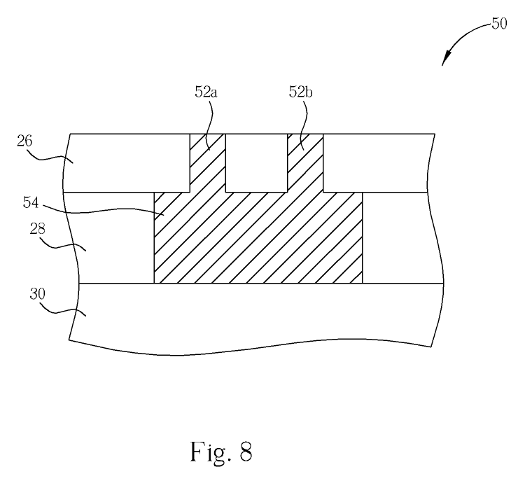

The embodiments of the inductor structure according to the present invention described above has a single conductive layer disposed as an upper layer, and one or a plurality of wall shape-like via plugs as conductive layers disposed under the single conductive layer. Such structure may be up side down and become another embodiments of the inductor structure according to the present invention, that is, one or a plurality of wall shape-like via plugs as conductive layers disposed as an upper layer, and the single conductive layer is disposed as a lower layer, such as those shown in FIGS. 7 and 8.

Please refer to FIG. 7, showing a cross-sectional view of the third embodiment according to the present invention. The inductor structure 40 is located in a semiconductor substrate 30. The semiconductor substrate 30 is as described above. The inductor structure 40 comprises a first conductive layer 42 and a second conductive layer 44. The first conductive layer 42 is in a spiral shape, disposed in the first dielectric layer 26, and comprises a same material as the topmost interconnect. The second conductive layer 44 is filled in a trench opening in the second dielectric layer 28 beneath the first conductive layer 42 and connects the bottom of the first conductive layer 42 with its top. The second conductive layer 44 has a same shape as the spiral shape which the first conductive layer 42 has and comprises a same material as the via plug.

Please refer to FIG. 8 showing a cross-sectional view of the fourth embodiment according to the present invention. The inductor structure 50 is located in a semiconductor substrate 30. The semiconductor substrate 30 is as described above. The inductor structure 50 comprises two first conductive layers 52a and 52b and a second conductive layer 54. The first conductive layers 54a and 54b are respectively filled in two trench openings in the first dielectric layer 26. The two first conductive layers are in a spiral shape and comprise a same material as the topmost interconnect. The second conductive layer 54 is disposed in the second dielectric layer 28 beneath the first conductive layers 54a and 54b and connect the bottoms of the first conductive layers 54a and 54b with its top. The second conductive layer has a same shape as the spiral shape which the first conductive layers have and comprise a same material as the via plug.

The inductor structure according to the present invention may comprise more layers of conductive layers combined as a whole. For example, when the semiconductor substrate has a multilevel interconnection structure further including a third dielectric layer under the second dielectric layer, and a second interconnect in the third dielectric layer, the inductor structure may further comprise a third conductive layer disposed in the third dielectric layer beneath the second conductive layer. The third conductive layer connects the bottom of the second conductive layer with its top, has a same shape as the spiral shape which the first conductive layer has, and comprises a same material as the second interconnect. Thus, the third conductive layer can be combine with the first and the second conductive layers to form an integrated one.

Further for example, the semiconductor substrate may further comprise a fourth dielectric layer beneath the third dielectric layer and at least one via plug disposed in the fourth dielectric layer. The inductor structure thus may further comprise a fourth conductive layer filled in a trench opening in the fourth dielectric layer beneath the third conductive layer. The fourth conductive layer connects the bottom of the third conductive layer with its top, has a same shape as the spiral shape which the first conductive layer has, and comprises a same material as the via plug.

Further for example, the semiconductor substrate may further comprise a fifth dielectric layer under the fourth dielectric layer and a third interconnect in the fifth dielectric layer. The inductor structure thus may further comprise a fifth conductive layer disposed in the fifth dielectric layer beneath the fourth conductive layer. The fifth conductive layer connects the bottom of the fourth conductive layer with its top, has a same shape as the spiral shape, and comprises a same material as the third interconnect.

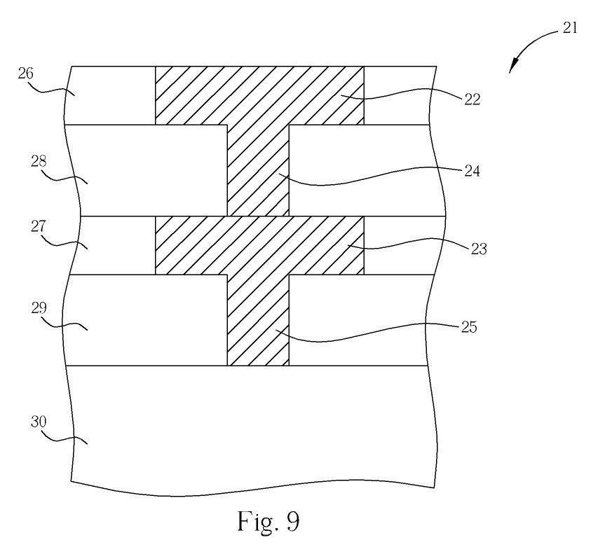

Please refer to FIG. 9 showing a schematically cross-sectional view of the fifth embodiment according to the present invention, which shows that the inductor structure according to the present invention may comprise more layers of conductive layers. The inductor structure 21 is located in a semiconductor substrate 30. The semiconductor substrate 30 comprises a topmost interconnect (not shown) in a first dielectric layer 26, a second dielectric layer 28 under the first dielectric layer, and at least one via (not shown) in the second dielectric layer and filled with a via plug (not shown) connecting the topmost interconnect, as described above, and further comprises a third dielectric layer 27 under the second dielectric layer 28, a second interconnect (not shown) disposed in the third dielectric layer 27, a fourth dielectric layer 29 under the third dielectric layer 27, and at least one via plug disposed in the fourth dielectric layer 29. The inductor structure 21 comprises a first conductive layer 22, a second conductive layer 24, and a third conductive layer 23, and may further comprise a fourth conductive layer 25. The first conductive layer 22 is in a spiral shape, disposed in the first dielectric layer 26, and comprises a same material as the topmost interconnect. The second conductive layer 24 is filled in a trench opening in the second dielectric layer 28 beneath the first conductive layer 22 and connects the bottom of the first conductive layer 22 with its top. The second conductive layer 24 has a same shape as the spiral shape which the first conductive layer 22 has and comprises a same material as the via plug. The third conductive layer 23 is disposed in the third dielectric layer 27 beneath the second conductive layer 24 and connects the bottom of the second conductive layer 24 with its top. The third conductive layer 23 has a same shape as the spiral shape which the first conductive layer 22 has and comprises a same material as the second interconnect. The inductor structure may further comprise a fourth conductive layer 25 filled in a trench opening in the fourth dielectric layer 29 beneath the third conductive layer 23 and connects the bottom of the third conductive layer 23 with its top. The fourth conductive layer 25 has a same shape as the spiral shape which the first conductive layer 22 has and comprises a same material as the via plug in the fourth dielectric layer 29.

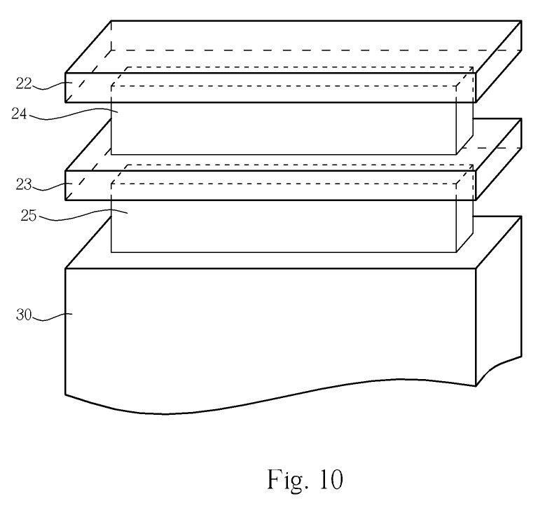

FIG. 10 shows a partial perspective view of the conductor structure shown in FIG. 9. The dielectric layers 26, 27, 28, 29 are not shown. It clearly shows that, in the inductor structure according to the present invention, the conductive layer disposed in the topmost layer of the interconnection structure is combined with conductive layers and via plugs disposed in one or more layers of the interconnection structure under the topmost layer to be as a whole, forming an inductor coil having an increased thickness.

The fabrication of the inductor structure according to the present invention is performed simultaneously at the time of forming the interconnection structure as fabricated with a conventional process. For example, a single damascene, dual damascene process, or aluminum deposition and melt process can be used, but not limited thereto.

All combinations and sub-combinations of the above-described features also belong to the present invention. Those skilled in the art will readily observe that numerous modifications and alterations of the device and method may be made while retaining the teachings of the invention. Accordingly, the above disclosure should be construed as limited only by the metes and bounds of the appended claims.

1. An inductor structure, located in a semiconductor substrate, the semiconductor substrate comprising a topmost interconnect in a first dielectric layer, a second dielectric layer under the first dielectric layer, and at least one via in the second dielectric layer and filled with a via plug connecting the topmost interconnect, the inductor structure comprising:
a first conductive layer in a spiral shape filled in a trench opening in the first dielectric layer and comprising a same material as the topmost interconnect; and
a second conductive layer in the second dielectric layer beneath the first conductive layer and connecting the bottom of the first conductive layer with its top, the second conductive layer having a same shape as the spiral shape and comprising a same material as the via plug.

2. The inductor structure as claimed in claim 1, wherein the first conductive layer and the second conductive layer comprises copper and a barrier layer is disposed between the first conductive layer and the first dielectric layer and between the second conductive layer and the second dielectric layer.

3. The inductor structure as claimed in claim 1, wherein the first dielectric layer and the second dielectric layer are formed to be a single layer.

4. The inductor structure as claimed in claim 1, wherein the first conductive layer and the second conductive layer comprise aluminum.

5. The inductor structure as claimed in claim 1, wherein the first conductive layer comprises copper and the second conductive layer comprise tungsten.

6. The inductor structure as claimed in claim 1, wherein the first conductive layer is a plurality of conductive layers respectively filled in a plurality of trench openings parallel in the first dielectric layer.

7. The inductor structure as claimed in claim 1, wherein, the semiconductor substrate has a multilevel interconnection structure and comprises a third dielectric layer beneath the second dielectric layer and a second interconnect in the third dielectric layer; and
the inductor structure further comprises a third conductive layer filled in a trench opening in the third dielectric layer beneath the second conductive layer and connecting the bottom of the second conductive layer with its top, the third conductive layer having a same shape as the spiral shape and comprising a same material as the second interconnect.

8. The inductor structure as claimed in claim 7, wherein, the semiconductor substrate further comprises a fourth dielectric layer beneath the third dielectric layer and at least one via plug disposed in the fourth dielectric layer; and
the inductor structure further comprises a fourth conductive layer in the fourth dielectric layer beneath the third conductive layer and connecting the bottom of the third conductive layer with its top, the fourth conductive layer having a same shape as the spiral shape and comprising a same material as the via plug.

9. The inductor structure as claimed in claim 8, wherein, the semiconductor substrate further comprises a fifth dielectric layer beneath the fourth dielectric layer and a third interconnect in the fifth dielectric layer; and the inductor structure further comprises a fifth conductive layer filed in a trench opening in the fifth dielectric layer beneath the fourth conductive layer and connecting the bottom of the fourth conductive layer with its top, the fifth conductive layer having a same shape as the spiral shape and comprising a same material as the third interconnect.
